(19) United States
(12) Patent Application Publication
(10) Pub. No.: US 2012/0191962 A1
(43) Pub. Date: Jul. 26, 2012

(54) SYSTEM AND METHOD FOR SIMULATING BIOS ROM OF COMPUTING DEVICE INTO VIRTUAL DISK

(75) Inventor: SAN-YI SHU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/237,965

(22) Filed: Sep. 21, 2011

(30) Foreign Application Priority Data
Jan. 21, 2011 (CN) 201110023848.2

(51) Int. Cl. G06F 15/177

(52) U.S. Cl. 713/2

(57) ABSTRACT

In a method for simulating a read only memory of a basic input/output system (BIOS ROM) of a computing device into a virtual disk, configuration information of the BIOS ROM is loaded into a disk booting sequence of the BIOS, and the BIOS ROM is set as a virtual disk that needs to be booted, when a POST program of the computing device is implemented. Free space of the BIOS ROM is obtained by scanning storage space of the BIOS ROM, and physical addresses of the free space are obtained in the BIOS ROM. The physical addresses are translated into LBA addresses. A virtual disk is created using the free space in the BIOS ROM according to the LBA addresses. Master boot record (MBR) of the computing device is read from a storage system of the computing device to bootstrap an operating system of the computing device through the virtual disk.

### BACKGROUND

1. Technical Field

Embodiments of the present disclosure relate generally to basic input/output system (BIOS) management technologies, and particularly to a system and method for simulating a BIOS read only memory (ROM) of a computing device into a virtual disk.

2. Description of Related Art

Many computing devices, such as a computer, typically include a basic input/output system (BIOS). The BIOS is composed of a plurality of software programs and is installed in a read only memory (ROM) of a computing device. The ROM is commonly called BIOS ROM. When the development of the BIOS is completed, all software programs need to be packed into a BIOS file, and then the BIOS file is written into the BIOS ROM, to finish installation of the BIOS. However, when some software programs of the BIOS need to be updated, all software programs of the BIOS need to be repacked and installed, which is very inconvenient and inefficient.

### BRIEF DESCRIPTION OF THE DRAWINGS

FIG. 1 is a block diagram of one embodiment of a computing device including a simulation system.

FIG. 2 is a block diagram of one embodiment of functional modules of the simulation system in FIG. 1.

FIG. 3 is a flowchart of one embodiment of a method for simulating a read only memory (ROM) of a basic input/output system (BIOS) of the computing device into a virtual disk using the simulation system of FIG. 1.

FIG. 4 is a schematic diagram illustrating one example of a storage space of the BIOS ROM and a storage space of a virtual disk.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

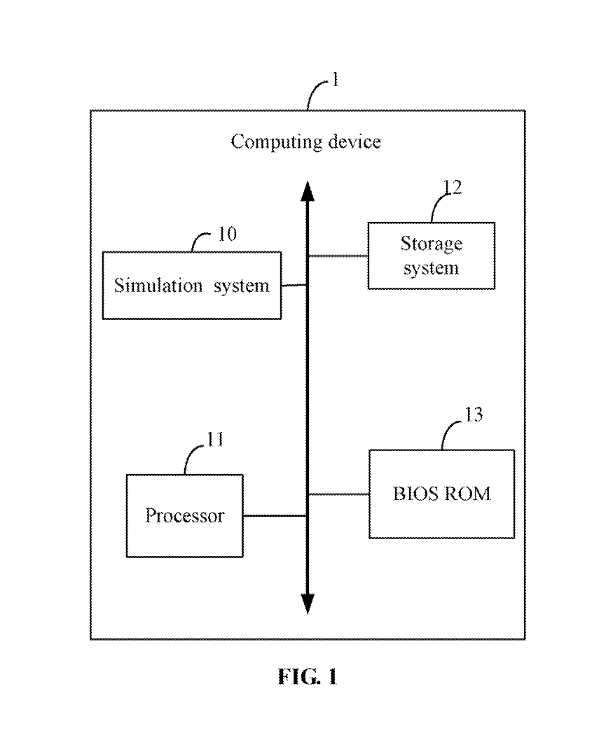

FIG. 1 is a block diagram of one embodiment of a computing device 1 including a simulation system 10. In the embodiment, the computing device 1 further includes a processor 11, a storage system 12, and a BIOS ROM 13. The BIOS ROM 13 is a read only memory (ROM) of a basic input/output system (BIOS) of the computing device 1, in which a plurality of software programs of the BIOS is installed. The simulation system 10 manages free space of the BIOS ROM 13, so that upgraded software programs of the BIOS can be independently installed in the BIOS ROM 13, where details are provided below. The free space is part of storage space of the BIOS ROM 13, in which no data is stored. It is understood that FIG. 1 is only one example of the computing device 1 and the computing device 1 can include more or fewer components than those shown in the embodiment, or a different configuration of the various components.

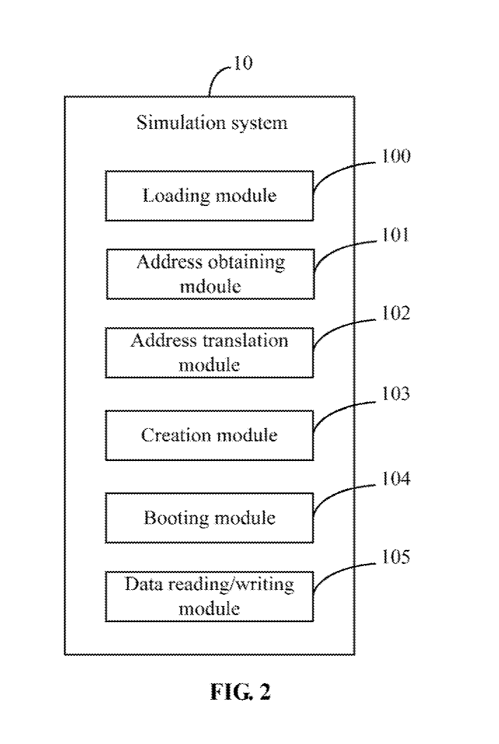

The simulation system 10 may include a plurality of software programs in the form of one or more computerized instructions stored in the storage system 12, and executed by the processor 11 to perform the operations of the computing device 1. In one embodiment, as shown in FIG. 2, the simulation system 10 includes a loading module 100, an address obtaining module 101, an address translation module 102, a creation module 103, a booting module 104, and a data reading/writing module 105. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The loading module 100 is operable to load configuration information of the BIOS ROM 13 into a disk booting sequence of the BIOS, and set the BIOS ROM 13 as a virtual disk that needs to be booted of the computing device 1, when a power on self test (POST) program of the computing device 1 is implemented. The disk booting sequence includes a plurality of disks of the computing device 1 that need to be tested and booted after the POST program is implemented, such as a hard disk, a CD ROM, and other hard disks of the computing device 1. The disk booting sequence may be stored in a complementary metal oxide semiconductor (CMOS) chip of the computing device 1. In one embodiment, the configuration information includes vendor identification (ID), a device ID, and a predetermined disk drive number of the BIOS ROM 13. The POST program is implemented when the computing device 1 is powered on.

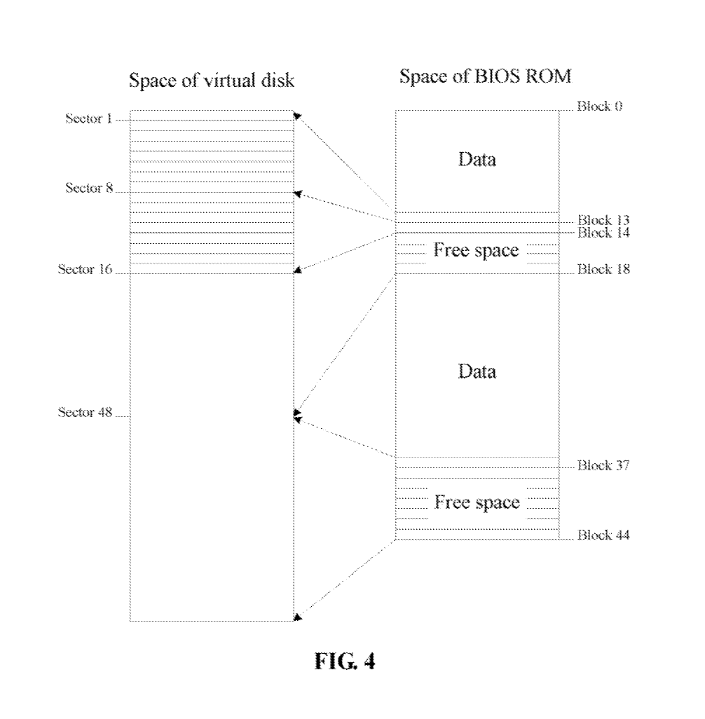

The address obtaining module 101 is operable to obtain free space of the BIOS ROM 13 by scanning the storage space of the BIOS ROM 13, and obtain physical addresses of the free space in the BIOS ROM 13, such as 0x005F to 0x00D5. In the embodiment, the free space include a plurality of memory blocks, such as block 13 to block 18, and block 37 to block 44, of FIG. 4.

The address translation module 102 is operable to translate the physical addresses of the free space into logical block addressing (LBA) addresses. In one embodiment, programs of the computing device 1 read data from the physical addresses by bytes, and write data into the physical addresses by blocks, where each block has a storage capacity of 4K bytes. The programs read data from or write data into LBA addresses of disks of the computing device 1 by sectors, and each sector has a storage capacity of 512 bits.

The creation module 103 is operable to create a virtual disk using the free space in the BIOS ROM according to the LBA addresses, and create a comparison table of the physical addresses and the LBA addresses. In one example, as shown in FIG. 4, the created virtual disk includes a plurality of sectors. For example, sector 1 to sector 8 of the virtual disk correspond to block 13 of the free space, and sector 8 to sector 16 correspond to block 14 of the free space.

The booting module 104 is operable to read master boot record (MBR) of the computing device 1 from the storage system 12 to bootstrap an operating system, such as a DOS system, of the computing device 1 through the virtual disk.

The data reading/writing module 105 is operable to read data from the BIOS ROM 13 or write data into the virtual disk if there is data needed to be read from or written into the virtual disk.

If there is data needed to be read from the virtual disk, the data reading/writing module 105 determines a LBA address of the data in the virtual disk, translates the determined LBA address of the data into a physical address of the BIOS ROM 13 according to the comparison table, and reads the data from the virtual disk according to the physical address.

If there is data, such as data of an upgraded software program of the BIOS, needed to be written into the virtual disk, the data reading/writing module 105 determines an LBA address for storing the data in the virtual disk, translates the determined LBA address into a physical address of the BIOS ROM 13 according to the comparison table, and writes the data into the virtual disk according to the physical address.

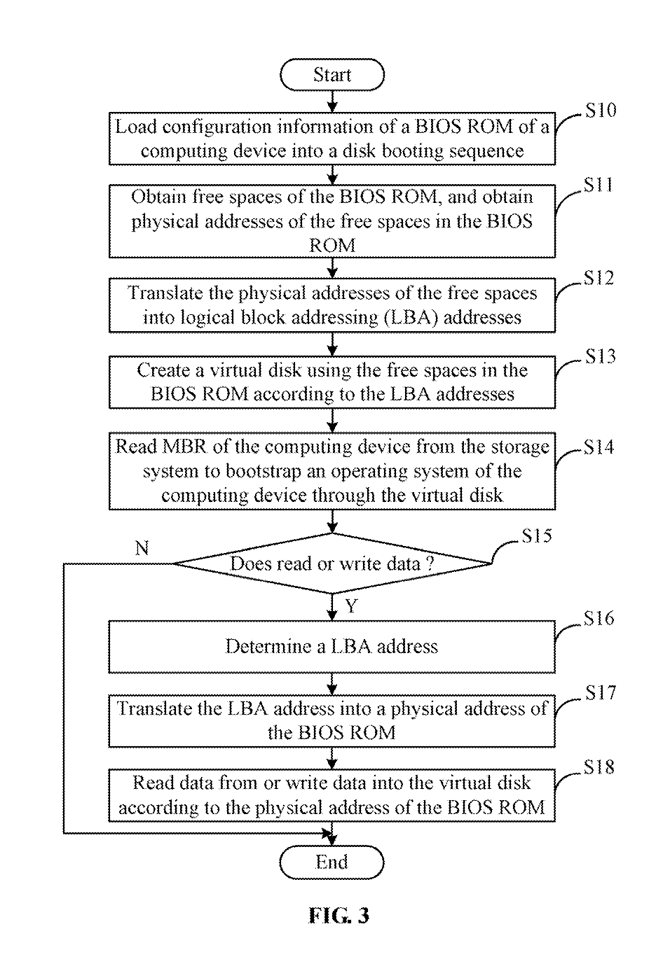

FIG. 3 is a flowchart of one embodiment of a method for simulating the BIOS ROM 13 of the computing device 1 into a virtual disk using the simulation system 10 of FIG. 1. Depending on the embodiment, additional blocks may be added, others removed, and the ordering of the blocks may be changed.

In block S10, the loading module 100 loads configuration information of the BIOS ROM 13 into a disk booting sequence of the BIOS, and sets the BIOS ROM 13 as a virtual disk that needs to be booted of the computing device 1 that needs to be booted, when a power on self test (POST) program of the computing device 1 is implemented. The disk booting sequence includes one or more disks of the computing device 1 that needs to be tested and booted after the POST procedure is finished, such as a hard disk, a CD ROM, and other hard disks of the computing device 1.

In block S11, the address obtaining module 101 obtains free space of the BIOS ROM 13 by scanning the storage space of the BIOS ROM 13, and obtains physical addresses of the free space in the BIOS ROM 13, such as 0x005F to 0x00D5. In the embodiment, the free space includes a plurality of memory blocks.

In block S12, the address translation module 102 translates the physical addresses of the free space into logical block addressing (LBA) addresses.

In block S13, the creation module 103 creates a virtual disk using the free space in the BIOS ROM according to the LBA addresses, and creates a comparison table of the physical addresses and the LBA addresses. In one example, as shown in FIG. 4, the created virtual disk includes a plurality of sectors.

In block S14, the booting module 104 reads master boot record (MBR) of the computing device 1 from the storage system 12, such as a hard disk of the computing device 1, to bootstrap an operating system, such as a DOS system, of the computing device 1 through the virtual disk.

In block S15, the data reading/writing module 105 determines if there is data needed to be read from or written into the virtual disk.

In block S16, if there is data needed to be read from the virtual disk, the data reading/writing module 105 determines a LBA address of the data in the virtual disk. If there is data needed to be written into the virtual disk, the data reading/writing module 105 determines a LBA address for storing the data in the virtual disk.

In block S17, the data reading/writing module 105 translates the determined LBA address into a physical address of the BIOS ROM 13 according to the comparison table.

In block S18, the data reading/writing module 105 reads the data from, or writes the data into, the virtual disk according to the physical address.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for simulating a read only memory of a basic input/output system (BIOS ROM) of a computing device into a virtual disk, the method comprising:
loading configuration information of the BIOS ROM into a disk booting sequence of the BIOS, and setting the BIOS ROM as a virtual disk that needs to be booted of the computing device, when a power on self test (POST) program of the computing device is implemented;
obtaining free space of the BIOS ROM by scanning storage space of the BIOS ROM, and obtaining physical addresses of the free space in the BIOS ROM;
translating the physical addresses of the free space into logical block addressing (LBA) addresses;
creating a virtual disk using the free space in the BIOS ROM according to the LBA addresses, and creating a comparison table of the physical addresses and the LBA addresses; and
reading master boot record (MBR) of the computing device from a storage system of the computing device to bootstrap an operating system of the computing device through the virtual disk.

2. The method according to claim 1, further comprising:
reading data from the virtual if there is data needed to be read from the virtual disk; and
writing data into the virtual disk if there is data needed to be written into the virtual disk.

3. The method according to claim 2, wherein the data is read from the virtual disk by:
determining a LBA address of the data in the virtual disk;
translating the determined LBA address of the data into a physical address of the BIOS ROM according to the comparison table; and
reading the data from the virtual disk according to the physical address.

4. The method according to claim 2, wherein the data is written into the virtual disk by:
determining a LBA address for storing the data in the virtual disk;
translating the determined LBA address into a physical address of the BIOS ROM according to the comparison table; and
writing the data into the virtual disk according to the physical address.

5. The method according to claim 1, wherein the disk booting sequence is stored in a complementary metal oxide semiconductor (CMOS) chip of the computing device, and includes one or more disks of the computing device that needs to be tested and booted after the POST program is implemented.

6. The method according to claim 1, wherein the configuration information comprise a vendor identification (ID), a device ID, and a predetermined disk drive number of the BIOS ROM.

7. A computing device, comprising:
at least one processor;
a storage system; and
one or more programs stored in the storage system and being executable by the at least one processor, the one or more programs comprising:
a loading module operable to load configuration information of the BIOS ROM into a disk booting sequence of the BIOS, and set the BIOS ROM as a virtual disk that needs to be booted of the computing device, when a power on self test (POST) program of the computing device is implemented;
an address obtaining module operable to obtain free space of the BIOS ROM by scanning storage space of the BIOS ROM, and obtain physical addresses of the free space in the BIOS ROM;
an address translation module operable to translate the physical addresses of the free space into logical block addressing (LBA) addresses; and
a creation module operable to create a virtual disk using the free space in the BIOS ROM according to the LBA addresses, and create a comparison table of the physical addresses and the LBA addresses; and
a booting module operable to read master boot record (MBR) of the computing device from the storage system to bootstrap an operating system of the computing device through the virtual disk.

8. The computing device according to claim 7, wherein the one or more programs further comprise:
a data reading/writing module operable to read data from the virtual disk when the data need to be read from the virtual disk, and write data into the virtual disk when the data need to be written into the virtual disk.

9. The computing device according to claim 8, wherein the data is read from the virtual disk by:
determining a LBA address of the data in the virtual disk;
translating the determined LBA address of the data into a physical address of the BIOS ROM according to the comparison table; and
reading the data from the virtual disk according to the physical address.

10. The computing device according to claim 8, wherein the data is written into the virtual disk by:
determining a LBA address for storing the data in the virtual disk;
translating the determined LBA address into a physical address of the BIOS ROM according to the comparison table; and
writing the data into the virtual disk according to the physical address.

11. The computing device according to claim 7, wherein the disk booting sequence is stored in a complementary metal oxide semiconductor (CMOS) chip of the computing device, and includes one or more disks of the computing device that needs to be tested and booted after the POST program is implemented.

12. The computing device according to claim 7, wherein the configuration information comprise a vendor identification (ID), a device ID, and a predetermined disk drive number of the BIOS ROM.

13. A non-transitory storage medium storing a set of instructions, the set of instructions capable of being executed by a processor of a computing device, cause the computing device to perform a method for simulating a read only memory of a basic input/output system (BIOS ROM) of the computing device into a virtual disk, the method comprising:
loading configuration information of the BIOS ROM into a disk booting sequence of the BIOS, and setting the BIOS ROM as a virtual disk that needs to be booted of the computing device, when a power on self test (POST) program of the computing device is implemented;
obtaining free space of the BIOS ROM by scanning storage space of the BIOS ROM, and obtaining physical addresses of the free space in the BIOS ROM;
translating the physical addresses of the free space into logical block addressing (LBA) addresses;
creating a virtual disk using the free space in the BIOS ROM according to the LBA addresses, and creating a comparison table of the physical addresses and the LBA addresses; and
reading master boot record (MBR) of the computing device from a storage system of the computing device to bootstrap an operating system of the computing device through the virtual disk.

14. The non-transitory storage medium according to claim 13, wherein the method further comprises:
reading data from the virtual disk if there is data needed to be read from the virtual disk; and
writing data into the virtual disk if there is data needed to be written into the virtual disk.

15. The non-transitory storage medium according to claim 14, wherein the data is read from the virtual disk by:
determining a LBA address of the data in the virtual disk;
translating the determined LBA address of the data into a physical address of the BIOS ROM according to the comparison table; and
reading the data from the virtual disk according to the physical address.

16. The non-transitory storage medium according to claim 14, wherein the data is written into the virtual disk by:
determining a LBA address for storing the data in the virtual disk;
translating the determined LBA address into a physical address of the BIOS ROM according to the comparison table; and
writing the data into the virtual disk according to the physical address.

17. The non-transitory storage medium according to claim 13, wherein the disk booting sequence is stored in a complementary metal oxide semiconductor (CMOS) chip of the computing device, and includes one or more disks of the computing device that needs to be tested and booted after the POST program is implemented.

18. The non-transitory storage medium according to claim 13, wherein the configuration information comprise a vendor identification (ID), a device ID, and a predetermined disk drive number of the BIOS ROM.
